(19) United States
(12) Patent Application Publication
(10) Pub. No.: US 2006/0235685 A1
(43) Pub. Date: Oct. 19, 2006

(54) Framework for voice conversion

(75) Inventors: Jani Nurminen, Lempaala (FI); Jilei Tian, Tampere (FI); Imre Kiss, Tampere (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/107,344

(22) Filed: Apr. 15, 2005

(51) Int. Cl. G10L 15/26

(52) U.S. Cl. 704/235

(57) ABSTRACT

This invention relates to a framework for converting a source speech signal associated with a source voice into a target speech signal that is a representation of the source speech signal associated with a target voice. The source speech signal is encoded into samples of encoding parameters, wherein the encoding comprises the step of segmenting the source speech signal into segments based on characteristics of the source speech signal. The samples of the encoding parameters, or a converted representation of the samples of the encoding parameters are then decoded to obtain the target speech signal. Therein, in the encoding, the decoding or in a separate step, samples of parameters related to the source speech signal are converted into samples of parameters related to the target speech signal. Therein, at least one of the encoding and the converting depends on the segments of the source speech signal.

### FIELD OF THE INVENTION

This invention relates to speech processing and in particular to a framework for converting a source speech signal associated with a source voice into a target speech signal, wherein said target speech signal is a representation of said source speech signal, but is associated with a target voice.

### BACKGROUND OF THE INVENTION

Voice conversion can be defined as the modification of speaker-identity related features of a speech signal. Commercial usage of voice conversion techniques has not been very popular yet. First, and foremost, voice conversion may be utilized to extend the language portfolio of Text-To-Speech (TTS) systems for branded voices in a cost efficient manner. In this context, voice conversion may for instance be used to make a branded synthetic voice speak in languages that the original voice talent cannot speak. In addition, voice conversion may be deployed in several types of entertainment applications and games, while there are also several new features that could be implemented using the voice conversion technology, such as text message reading with the voice of the sender.

A plurality of voice conversion techniques are already known in the art. Therein, a speech signal is frequently represented by a source-filter model of speech, wherein speech is understood to be comprised of a source component originating from the vocal cords, which is then shaped by a filter imitating the effect of the vocal tract. The source component is frequently also denoted as an excitation signal, as it excites the vocal tract filter. A separation (or deconvolution) of a speech signal into the excitation signal on the one hand, and the vocal tract filter on the other hand can for instance be accomplished by cepstral analysis or Linear Predictive Coding (LPC).

LPC is a method of predicting a sample of a speech signal s(n) as a weighted sum of a number p of previous samples. This number p of previous samples is denoted as the order of the LPC. The weights aₖ (or LPC coefficients) applied to the previous samples are chosen in order to minimize the squared error between the original sample and its predicted value, i.e. the error signal e(n), which is sometimes referred to as LPC residual, is desired to be as small as possible. Applying the z-transform, it is then possible to express the error signal E(z) as the product of the original speech signal S(z) and a transfer function A(z) that entirely depends on the weights aₖ. The spectrum of the error signal E(z) will have different structure depending on whether a sound it comes from is voiced or unvoiced. Voiced sounds are produced by vibrations of the vocal cords. Their spectrum is periodic with some fundamental frequency (which corresponds to the pitch). This motivates to consider the error signal E(z) as a representative of the excitation, and to consider the transfer function A(z) as a representative of the vocal tract filter. The weights aₖ that determine the transfer function A(z) can for instance be determined by applying an autocorrelation or covariance method to the speech signal. LPC coefficients can also be represented by Line Spectrum Frequencies (LSFs), which may be more suitable for exploiting certain properties of the human auditory system.

Publication “Design and Evaluation of a Voice Conversional Algorithm Based on Spectral Envelope Mapping and Residual Prediction” by Kain, A. and Macon, M. W., presented in Proceedings International Conference on Acoustics, Speech and Signal Processing (ICASSP), May 7-11, 2001, Salt Lake City, Utah, presents a state-of-the-art speech conversion system that is based on a source-filter representation of the speech signal. Therein, both the LPC coefficients related to the vocal tract filter and the LPC residual related to the excitation signal are changed to achieve voice conversion of a speech signal. To this end, first a pitch-synchronous sinusoidal analysis of a source speech signal is performed over two pitch periods. The discrete magnitude spectrum is then up-sampled and warped using the Bark scale. An application of the Levinson-Durbin algorithm on the autocorrelation sequence yields the LPC filter coefficients, which are transformed into LSFs. The actual voice conversion, at least with respect to the vocal tract, is then achieved by converting these LSFs (related to the source speech signal) into LSFs of a target speech signal according to a Gaussian Mixture Modeling (GMM) approach, which has been trained with speech samples of both the source and target voice.

This is achieved by joining the source and target LSF vectors to from a new vector space. A GMM of this vector space is then estimated by the Expectation-Maximization (EM) algorithm, initialized by a generalized Lloyd algorithm. After the log-likelihood stabilizes, a regression is performed which calculates the linear transformation components of the locally linear, probabilistic conversion function.

To further increase voice conversion performance, the Kain et al. publication proposes to restrict conversion not only to the LSFs, but also to take conversion of the LPC residual into account. This can be achieved by predicting the target LPC residual from LPC coefficients of the source signal during voiced speech.

The general idea of predicting the target LPC residual to improve voice conversion is also disclosed in publication “A Study on Residual Prediction Techniques for Voice Conversion” by Sündermann, D., Bonafonte, A. and Ney, H., presented in Proceedings ICASSP, Mar. 18-23, 2005, Philadelphia, Pa. In this publication, also a trivial solution, which dispenses with the prediction of the LPC residual and uses the converted source LPC residual directly as target LPC residual, is proposed.

Finally, in the publication “Voice Conversion Through Vector Quantization” by Abe. M., Nakamura, S., Shikano, K. and Kuwabara, H., presented in Proceedings ICASSP, Apr. 11-14, 1998, New York City, N.Y., USA, a direct conversion of the entire LPC residual is proposed.

However, these prior art voice conversion techniques have certain shortcomings such as low performance in speaker identity modification, low output speech quality, high computational complexity, high memory requirements, limited flexibility and sensitivity to degradations in the source speech signal.

### SUMMARY OF THE INVENTION

In view of the above-mentioned problems, it is, inter alia, an object of the present invention to provide a framework for an improved conversion of a source speech signal associated with a source voice into a target speech signal that is a representation of said source speech signal associated with a target voice.

According to a first aspect of the present invention, a method for converting a source speech signal associated with a source voice into a target speech signal that is a representation of said source speech signal associated with a target voice is proposed. Said method comprises encoding said source speech signal into samples of encoding parameters, wherein said encoding comprises the step of segmenting said source speech signal into segments based on characteristics of said source speech signal; decoding one of said samples of said encoding parameters and a converted representation of said samples of said encoding parameters to obtain said target speech signal; and converting, in one of said encoding, said decoding and a separate step, samples of parameters related to said source speech signal into samples of parameters related to said target speech signal. Therein, at least one of said encoding and said converting depends on said segments of said source speech signal.

Apart from said segmenting, said encoding may for instance further comprise determining and/or estimating samples of parameters representative of said source speech signal, transforming said samples of said parameters (for instance by conversion), compressing said samples of said parameters (for instance by reducing an update rate of said samples), and quantizing said samples of said parameters or transformed and/or compressed representations thereof.

In contrast to prior art voice conversion techniques, according to the present invention, a segmentation of the source speech signal is performed during the encoding, wherein said segmentation is based on characteristics of said source speech signal, for instance voicing characteristics, gain characteristics or pitch characteristics, to name but a few. Said encoding and/or said converting depend on said segments of said source speech signal. This may for instance allow to advantageously adapt said encoding (for instance an extent thereof) and/or said converting to the signal characteristics of the source speech signal in order to increase the efficiency and/or the quality of said encoding and/or said conversion.

Said converting of said samples of said parameters related to said source speech signal into said samples of said parameters related to said target speech signal may be flexibly performed during said encoding, during said decoding, or in a separate step. In the first case, said samples of said encoding parameters obtained from said encoding with conversion then are associated with said samples of said parameters that are related to said target speech signal (they may for instance be equal to said samples, or be downsampled and/or quantized representations of said samples). In the second case, said samples of said encoding parameters obtained from said encoding without conversion then are associated with said samples of said parameters that are related to said source speech signal (they may for instance be equal to said samples, or be downsampled and/or quantized representations of said samples). In the third case, where conversion is performed outside said encoding and decoding, said samples of said encoding parameters obtained from said encoding are then associated with said samples of said parameters that are related to said source speech signal as in the first case. A converted representation of said samples of said encoding parameters, obtained from said conversion, is then associated with said samples of said parameters that are related to said target speech signal (they may for instance be equal to said samples).

Said encoding parameters and said parameters related to said source and target speech signals may for instance be related to a source-filter model of said speech signals, but may equally well be related to all other types of speech signal models as well.

According to an embodiment of the first aspect of the present invention, said encoding comprises the step of assigning said segments of said source speech signal segment types. Said segment types may for instance be related to voicing and/or gain characteristics of said source speech signal.

According to a further embodiment of the first aspect of the present invention, said converting of said samples of parameters related to said source speech signal into said samples of parameters related to said target speech signals depends on said assigned segment types. For instance, different types of conversion may be performed for samples of parameters in segments of said source speech signal that are assigned different segment types.

According to a further embodiment of the first aspect of the present invention, an extent of said encoding of said source speech signal in said segments depends on said assigned segment types.

According to this embodiment of the present invention, said extent of said encoding may be related to at least one of update rates for said samples of said encoding parameters and numbers of bits allocated for a quantization of said samples of said encoding parameters.

According to this embodiment of the present invention, said segment types may be associated with desired accuracies in reconstructing of said source speech signal from said samples of said parameters related to said source speech signal, and wherein said extent of said encoding of said source speech signal in said segments depends on said desired accuracies. For instance, a first segment type may be associated with a high desired reconstruction accuracy, and a second segment type may be associated with a low desired reconstruction accuracy, and then a large extent of encoding is spent on a segment of said first segment type and a smaller extent of encoding is spent on a segment of said second segment type.

According to a further embodiment of the first aspect of the present invention, said encoding parameters, said parameters related to said source speech signal and said parameters related to said target speech signal are parameters of a parametric speech signal model that comprises a vocal tract model and an excitation model. This parametric model is particularly flexible and efficient, and is also in line with the human speech production system.

According to this embodiment of the present invention, said parameters related to said source and target speech signals may comprise at least a pitch parameter, a voicing parameter, a gain parameter and spectral vectors representing an excitation of said source and target speech signals.

According to a further embodiment of the first aspect of the present invention, said parameters related to said source and target speech signals comprise line spectrum frequency coefficients, and in said converting, samples of line spectrum frequency coefficients related to said source speech signal are converted into samples of line spectrum frequency coefficients related to said target speech signal based on a data-driven model that is trained with speech signal samples associated with said source voice and speech signal samples associated with said target voice. In said training of said model, different segment types of said speech signal samples may be considered to allow for segment-type dependent conversion. Said data-driven model may for instance represent a Gaussian Mixture Modeling (GMM) approach.

According to a further embodiment of the first aspect of the present invention, said parameters related to said source and target speech signals comprise a pitch parameter, and in said converting, samples of a pitch parameter related to said source speech signal are converted into samples of a pitch parameter related to said target speech signal based on a data-driven model that is trained with speech signal samples associated with said source voice and speech signal samples associated with said target voice. In said training of said model, different segment types of said speech signal samples may be considered to allow for segment-type dependent conversion. Said data-driven model may for instance represent a Gaussian Mixture Modeling (GMM) approach.

According to a further embodiment of the first aspect of the present invention, said parameters related to said source and target speech signals comprise a pitch parameter, and in said converting, samples of a pitch parameter related to said source speech signal are converted into samples of a pitch parameter related to said target speech signal based on moments of said source and target voice. Said moments may for instance be mean and variance. Said moments may also consider different segment types to allow for segment-type dependent conversion.

According to a further embodiment of the first aspect of the present invention, said parameters related to said source and target speech signals comprise a voicing parameter, and in said converting, samples of a voicing parameter related to said source speech signal are converted into samples of a voicing parameter related to said target speech signal based on a model that captures the differences in the degree of voicing between said source and target voice. Said model may also consider different segment types to allow for segment-type dependent conversion.

According to a further embodiment of the first aspect of the present invention, said parameters related to said source and target speech signals comprise a gain parameter, and in said converting, samples of a gain parameter related to said target speech signal are set equal to samples of a gain parameter related to said source speech signal.

According to a further embodiment of the first aspect of the present invention, said parameters related to said source and target speech signal comprise spectral vectors representing an excitation of said source and target speech signals, and wherein in said converting, samples of spectral vectors related to said source speech signal are converted into samples of spectral vectors related to said target speech signal based on a data-driven model that is trained with speech signal samples associated with said source voice and speech signal samples associated with said target voice. In said training, different segment types of said speech signal samples may be differentiated to obtain segment-type specific conversion models. Said data-driven model may for instance represent a Gaussian Mixture Modeling (GMM) approach.

According to this embodiment of the present invention, in said converting, a dimension conversion technique may be applied to said spectral vectors.

According to a second aspect of the present invention, a device for converting a source speech signal associated with a source voice into a target speech signal that is a representation of said source speech signal associated with a target voice is proposed. Said device comprises an encoder for encoding said source speech signal into samples of encoding parameters, wherein said encoder comprises means arranged for segmenting said source speech signal into segments based on characteristics of said source speech signal, a decoder for decoding one of said samples of said encoding parameters and a converted representation of said samples of said encoding parameters to obtain said target speech signal; and a converter for converting samples of parameters related to said source speech signal into samples of parameters related to said target speech signal, wherein said converter is comprised in one of said encoder, said decoder and a separate unit; wherein at least one of said encoder and said converter are arranged to operate in dependence on said segments of said source speech signal. Said device may for instance be a module in a speech processing system or a multimedia and/or telecommunications device.

According to an embodiment of the second aspect of the present invention, said encoding parameters, said parameters related to said source speech signal and said parameters related to said target speech signal are parameters of a parametric speech signal model that comprises a vocal tract model and an excitation model.

According to a further embodiment of the second aspect of the present invention, said converter is arranged to convert samples of line spectrum frequency coefficients related to said source speech signal into samples of line spectrum frequency coefficients related to said target speech signal based on a data-driven model that is trained with speech signal samples associated with said source voice and speech signal samples associated with said target voice.

According to a further embodiment of the second aspect of the present invention, said converter is arranged to convert samples of a pitch parameter related to said source speech signal into samples of a pitch parameter related to said target speech signal based on a data-driven model that is trained with speech signal samples associated with said source voice and speech signal samples associated with said target voice.

According to a further embodiment of the second aspect of the present invention, said converter is arranged to convert samples of a pitch parameter related to said source speech signal into samples of a pitch parameter related to said target speech signal based on moments of said source and target voice.

According to a further embodiment of the second aspect of the present invention, said converter is arranged to convert samples of a voicing parameter related to said source speech signal into samples of a voicing parameter related to said target speech signal based on a model that captures the differences in the degree of voicing between said source and target voice.

According to a further embodiment of the second aspect of the present invention, said converter is arranged to set samples of a gain parameter related to said target speech signal equal to samples of a gain parameter related to said source speech signal.

According to a further embodiment of the second aspect of the present invention, said converter is arranged to convert samples of spectral vectors representing an excitation of said source speech signal into samples of spectral vectors representing an excitation of said target speech signal based on a data-driven model that is trained with speech signal samples associated with said source voice and speech signal samples associated with said target voice.

According to a third aspect of the present invention, a software application product is proposed. Said software application product is embodied in an electronically readable medium for use in conjunction with a device for converting a source speech signal associated with a source voice into a target speech signal that is a representation of said source speech signal associated with a target voice. Said software application product comprises program code for causing a digital processor to encode said source speech signal into samples of encoding parameters, said program code for causing said digital processor to encode said source speech signal into samples of encoding parameters comprising program code for causing said digital processor to segment said source speech signal into segments based on characteristics of said source speech signal. Said software application product further comprises program code for causing said digital processor to decode one of said samples of said encoding parameters and a converted representation of said samples of said encoding parameters to obtain said target speech signal, and program code for causing said digital processor to convert, in one of said encoding, said decoding and a separate step, samples of parameters related to said source signal into samples of parameters related to said target signal. Said program code causes said digital processor to perform at least one of said encoding operation and said converting operation in dependence on said segments of said source speech signal.

According to a fourth aspect of the present invention, a device in a framework for converting a source speech signal associated with a source voice into a target speech signal that is a representation of said source speech signal associated with a target voice is proposed. Said device comprises an encoder for encoding said source speech signal into samples of encoding parameters that lend themselves to decoding to obtain said target speech signal, wherein said encoder comprises means arranged for segmenting said source speech signal into segments based on characteristics of said source speech signal, wherein said encoder comprises a converter for converting samples of parameters related to said source speech signal into samples of parameters related to said target speech signal, and wherein at least one of said encoding and said converting depends on said segments of said source speech signal.

According to a fifth aspect of the present invention, a device in a framework for converting a source speech signal associated with a source voice into a target speech signal that is a representation of said source speech signal associated with a target voice is proposed. Said device comprises a converter for converting samples of encoding parameters into a converted representation of said samples of said encoding parameters, wherein said samples of said encoding parameters are encoded from a source speech signal, wherein said encoding comprises the step of segmenting said source speech signal into segments based on characteristics of said source speech signal, wherein said converted representation of said samples of said encoding parameters lends itself to decoding to obtain said target speech signal, and wherein at least one of said encoding and said converting depends on said segments of said source speech signal.

According to a sixth aspect of the present invention, a device in a framework for converting a source speech signal associated with a source voice into a target speech signal that is a representation of said source speech signal associated with a target voice is proposed. Said device comprises a decoder for decoding samples of encoding parameters to obtain said target speech signal, wherein said samples of said encoding parameters are obtained by encoding said source speech signal, wherein said encoding comprises the step of segmenting said source speech signal into segments based on characteristics of said source speech signal, wherein said decoder comprises a converter for converting samples of parameters related to said source speech signal into samples of parameters related to said target speech signal, and wherein at least one of said encoding and said converting depends on said segments of said source speech signal.

According to a seventh aspect of the present invention, a telecommunications device being capable of converting a source speech signal associated with a source voice into a target speech signal that is a representation of said source speech signal associated with a target voice is proposed. Said telecommunications device comprises an encoder for encoding said source speech signal into samples of encoding parameters, wherein said encoder comprises means arranged for segmenting said source speech signal into segments based on characteristics of said source speech signal, a decoder for decoding one of said samples of said encoding parameters and a converted representation of said samples of said encoding parameters to obtain said target speech signal; and a converter for converting samples of parameters related to said source speech signal into samples of parameters related to said target speech signal, wherein said converter is comprised in one of said encoder, said decoder and a unit that is separate from said encoder and said decoder; wherein at least one of said encoder and said converter are arranged to operate in dependence on said segments of said source speech signal. Said telecommunications device may for instance be a mobile phone.

According to an eighth aspect of the present invention, a text-to-speech system being capable of converting a source speech signal associated with a source voice into a target speech signal that is a representation of said source speech signal associated with a target voice is proposed, said text-to-speech system comprising a text-to-speech converter for converting a source text into said source speech signal; an encoder for encoding said source speech signal into samples of encoding parameters, wherein said encoding comprises the step of segmenting said source speech signal into segments based on characteristics of said source speech signal; a decoder for decoding one of said samples of said encoding parameters and a converted representation of said sample of said encoding parameters to obtain said target speech signal, and a converter for converting samples of parameters related to said source speech signal into samples of parameters related to said target speech signal, wherein said converter is comprised in one of said text-to-speech converter, said encoder, said decoder and a unit that is separate from said text-to-speech converter, encoder and decoder; wherein at least one of said encoder and converter is arranged to operate in dependence on said segments of said source speech signal.

Said text-to-speech system may for instance be deployed in order to read textual information such as a message or a menu structure of an electronic device to a visually impaired person or to a person that does not want to read the textual information and prefers to have it read, as for instance a driver of a car that receives a textual traffic message that then can be perceived by him without requiring him to look at a display that displays said message.

These and other aspects of the invention will be apparent from and elucidated with reference to the embodiments described hereinafter.

### BRIEF DESCRIPTION OF THE FIGURES

In the figures show:

FIG. 1a: A schematic block diagram of an embodiment of a framework for voice conversion according to the present invention;

FIG. 1b: a schematic block diagram of a further embodiment of a framework for voice conversion according to the present invention;

FIG. 1c: a schematic block diagram of a further embodiment of a framework for voice conversion according to the present invention;

FIG. 2a: a schematic block diagram of an embodiment of a telecommunications device comprising a voice conversion unit according to the present invention;

FIG. 2b: a schematic block diagram of a further embodiment of a telecommunications device comprising components of a framework for voice conversion according to the present invention;

FIG. 2c: a schematic block diagram of a further embodiment of a telecommunications device comprising components of a framework for voice conversion according to the present invention;

FIG. 3a: a schematic block diagram of an embodiment of a text-to-speech system comprising a voice conversion unit according to the present invention;

FIG. 3b: a schematic block diagram of a further embodiment of a text-to-speech system according to the present invention;

FIG. 3c: a schematic block diagram of a further embodiment of a text-to-speech system according to the present invention;

FIG. 4a: a schematic block diagram of an embodiment of an encoder in a framework for voice conversion according to the present invention;

FIG. 4b: a schematic block diagram of a further embodiment of an encoder in a framework for voice conversion according to the present invention;

FIG. 5a: a schematic block diagram of an embodiment of a decoder in a framework for voice conversion according to the present invention;

FIG. 5b: a schematic block diagram of a further embodiment of a decoder in a framework for voice conversion according to the present invention;

FIG. 6: a schematic block diagram of an embodiment of a converter for a framework for voice conversion according to the present invention;

FIG. 7a: a time plot of a speech signal segmented according to the present invention;

FIG. 7b: a time plot of the energy associated with the segmented speech signal of FIG. 7a;

FIG. 7c: a time plot of the voicing information associated with the segmented speech signal of FIG. 7a;

FIG. 7d: a time plot of the segment types associated with the segmented speech signal of FIG. 7a; and

FIG. 8: a flowchart of an embodiment of an adaptive downsampling and quantization algorithm according to an embodiment of the present invention.

### DETAILED DESCRIPTION OF THE INVENTION

The present invention proposes a framework for voice conversion. Therein, a source speech signal associated with a source voice is converted into a target speech signal that is a representation of said source speech signal, but is associated with a target voice. Said source speech signal is encoded into samples of encoding parameters, wherein said encoding comprises the step of segmenting said source speech signal into segments based on characteristics of said source speech signal, and said samples of said encoding parameters or a converted representation of said samples are then decoded to obtain said target speech signal. During said encoding or said decoding, or in a separate step, samples of parameters related to said source signal are converted into samples of parameters related to said target signal.

The framework according to the present invention determines a segmentation of the source speech signal during encoding and exploits this segmentation in said encoding and/or said converting. Therein, the segmentation takes the time-variant characteristics of the source speech signal into account. Furthermore, a parametric speech model, comprising a vocal tract model and an excitation model is used in both encoding and conversion. This allows for a high-quality voice conversion. As the framework comprises the possibility to compress the source speech signal during encoding, encoding is particularly efficient and allows to deploy the framework also in the context of mobile applications which are characterized by low transmission bandwidths and limited memory. Furthermore, the framework allows the parameter conversion to be implemented in the encoder, the decoder and also in a separate converter, thus for instance allowing for a flexible distribution of computational complexity among a device that houses said encoder, a device that houses said converter and a device that houses said decoder.

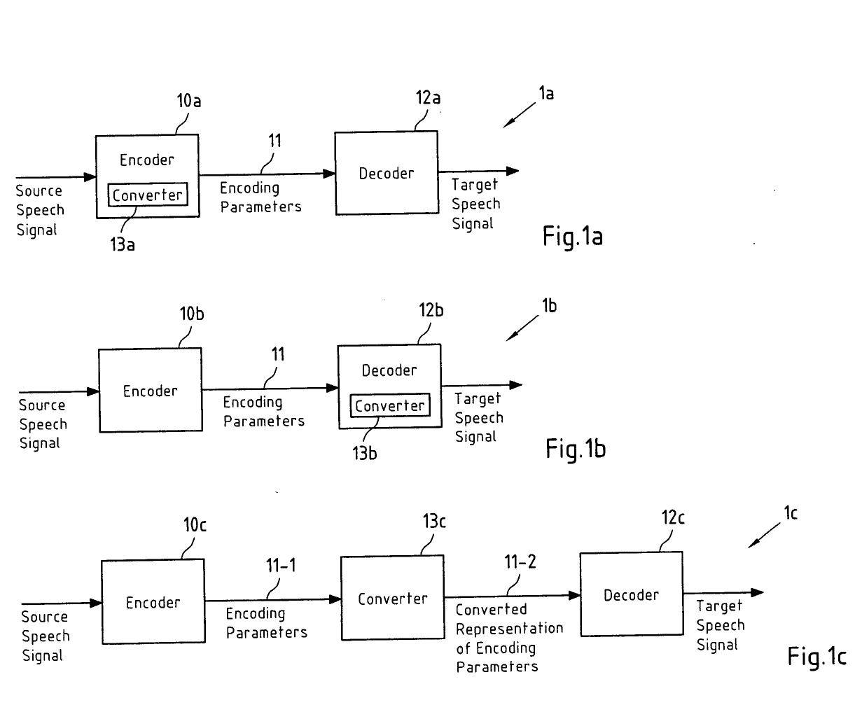

FIGS. 1a-1c depict block diagrams of embodiments of frameworks 1a, 1b and 1c for voice conversion according to the present invention.

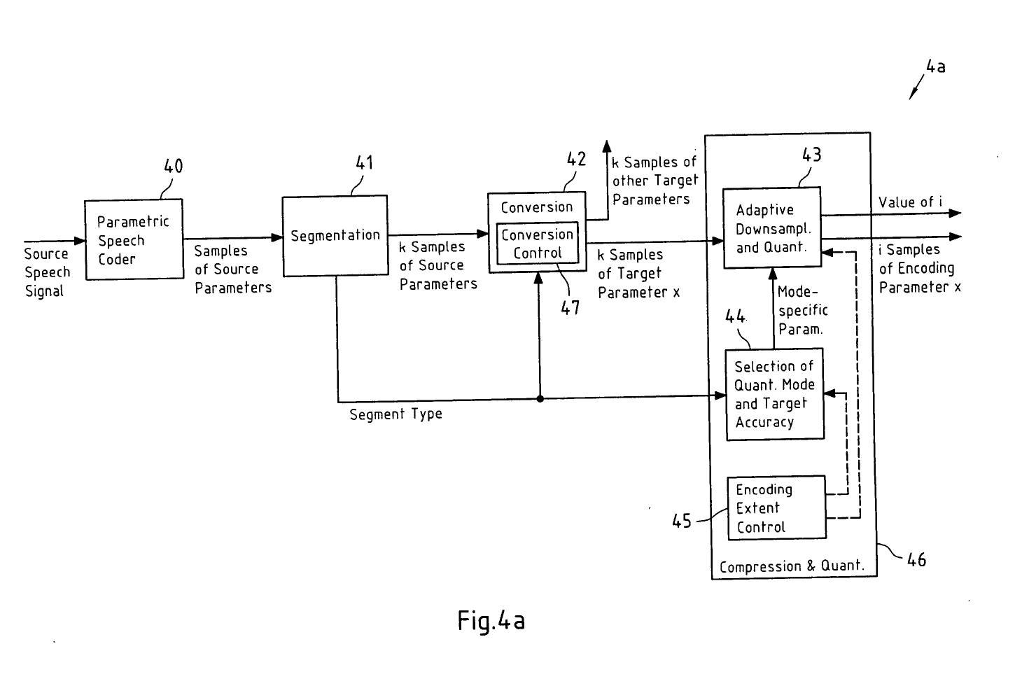

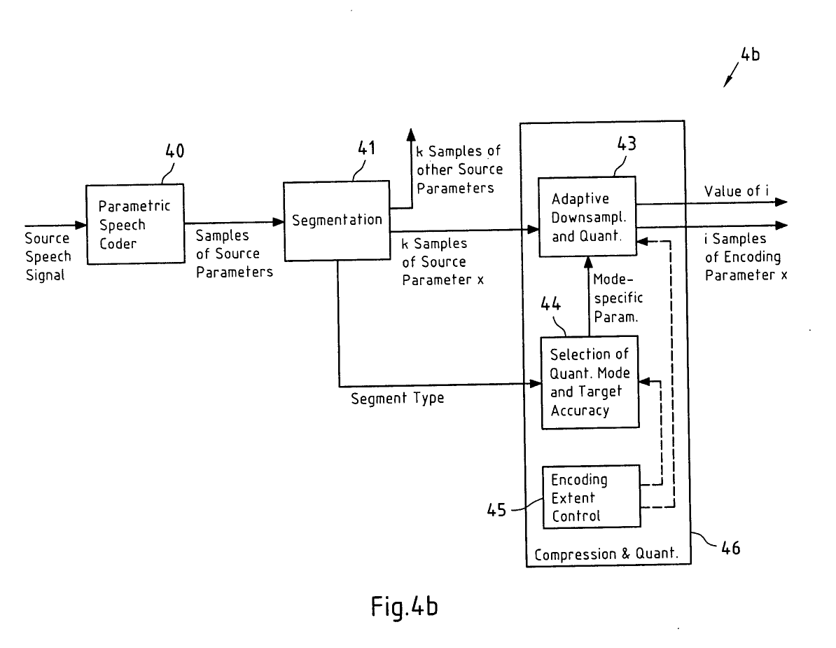

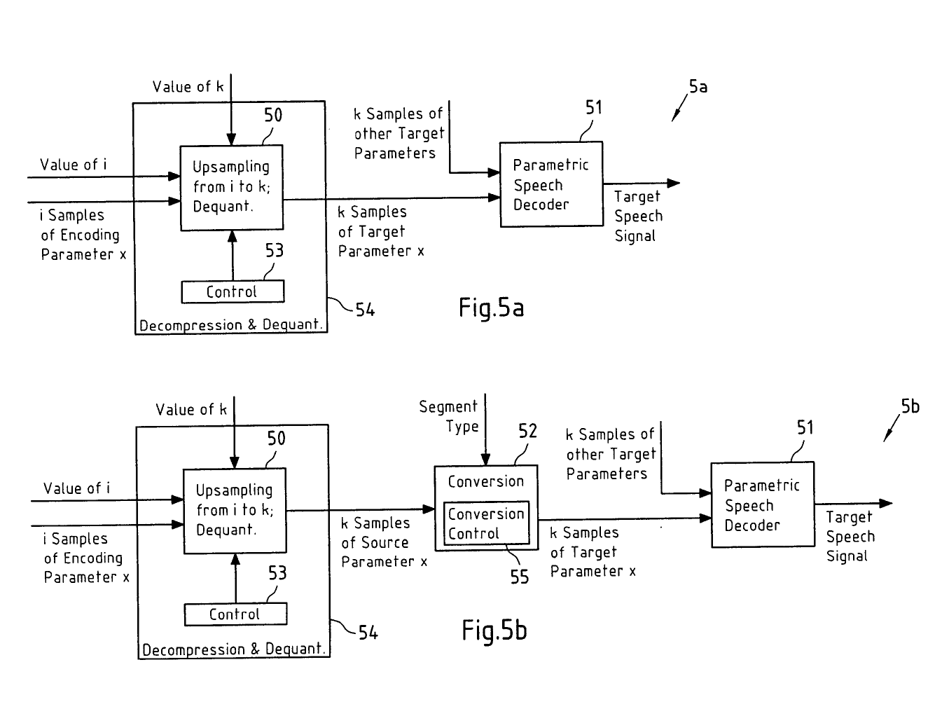

Turning to FIGS. 1a and 1b first, in each framework 1a/1b, a source speech signal that is associated with a source voice is fed into an encoder 10a/10b that encodes said source speech signal into samples of encoding parameters, as will be discussed in more detail with respect to FIGS. 4a and 4b below. The samples of the encoding parameters are then transferred via a link 11 to decoder 12a/12b, where a target speech signal is obtained by means of decoding, as will be discussed in more detail with reference to FIGS. 5a and 5b below. As already stated, said target speech signal is a representation of said source speech signal, but is associated with a target voice that is different from said source voice. The actual conversion of the source voice into the target voice is accomplished by a converter, which may either be located in the encoder or in the decoder. In framework 1a, encoder 10a is understood to house the converter 13a, wherein in framework 1b, decoder 12b is understood to house the converter 13b. Both converters 13a/13b convert samples of parameters that are related to the source speech signal (denoted as source parameters in the sequel) into samples of parameters that are related to the target signal (denoted as target parameters in the sequel). More details on the choice of the parameters and the applied conversion techniques will be discussed below.

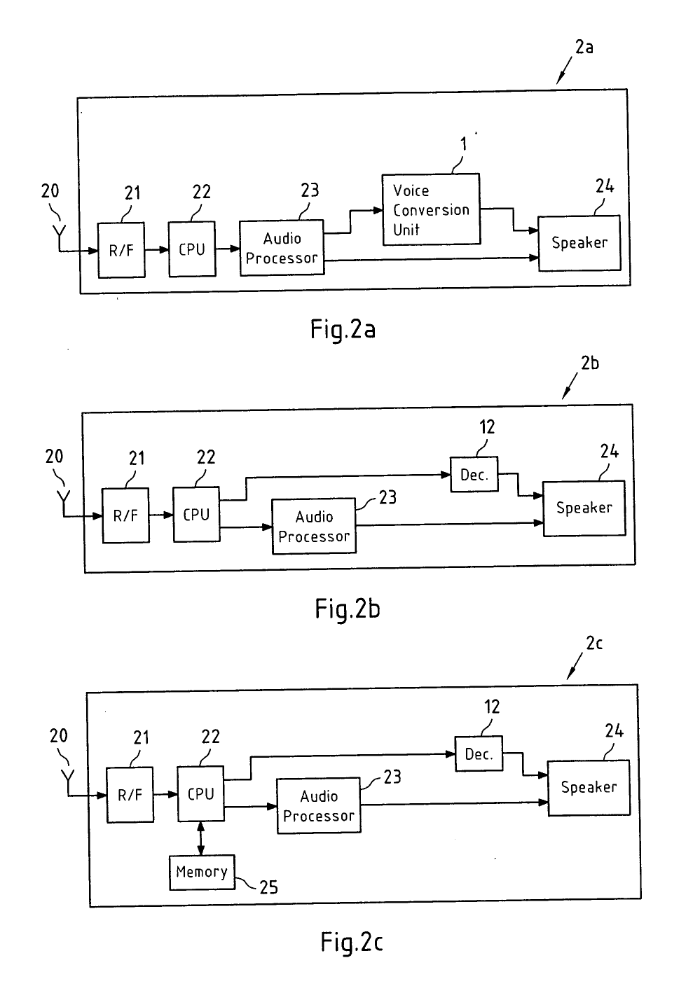

It is important to note that the encoder 10a/10b and the decoder 12a/12b of the framework 1a/1b can be implemented in the same device, as for instance in a module of a speech processing system. Then said link 11 may be a simple electrical connection. Equally well, said encoder 10a/10b and said decoder 12a/12b may be implemented in different devices, and then said link 11 may represent a transmission link between said devices, for instance a wireless link. Locating the encoder 10a/10b and the decoder 12a/12b in different devices may be of particular advantage in the context of a telecommunications system, as will be discussed with reference to FIGS. 2a-2c below.

FIG. 1c depicts a further embodiment of a framework 1c for voice conversion according to the present invention, wherein the converter 13c is housed in a unit that is separate from said encoder 10c and said decoder 12c. Therein, encoder 10c performs the encoding of a source speech signal into encoding parameters, which are transferred via link 11-1 to converter 13c. Converter 13c outputs a converted representation of the samples of the encoding parameters and forwards them via link 11-2 to decoder 12c, which decodes the converted representation of the samples of the encoding parameters to obtain the target speech signal. The components 10c, 13c and 12c of the framework 1c of FIG. 1c can be housed in one device, and then said links 11-1 and 11-2 may for instance be electrical connections between said components, or can be housed in one or more different devices or systems, and then said links 11-1 and 11-2 may be wired or wireless transmission links between said devices or systems. The detailed functionality of encoder 10c, converter 13c and decoder 12c will be discussed below with reference to FIGS. 4a and 4b, FIG. 6 and FIGS. 5a and 5b, respectively.

FIG. 2a depicts a block diagram of a telecommunications device 2a such as for instance a mobile phone that is operated in a mobile communications system. Said device 2a comprises an antenna 20, an R/F instance 21, a Central Processing Unit (CPU) 22, an audio processor 23 and a speaker 24. A typical use case of such a device 2a is the establishment of a call via a core network of said mobile communications system. In the schematic representation of FIG. 2a, only the components of device 2a that are of interest for reception of speech signals are shown. Electromagnetic signals carrying a representation of speech signals are for instance received via antenna 20, amplified, mixed and analog-to-digital converted by R/F instance 21 and forwarded to CPU 22, which processes the digital speech signal and triggers audio processor 23 to generate a corresponding analog speech signal that can be emitted by speaker 24.

However, according to the present invention, device 2a is further equipped with a voice conversion unit 1, which may be implemented according to the frameworks 1a of FIG. 1a, 1b of FIG. 1b or 1c of FIG. 1c. This voice conversion unit 1 is capable of converting a voice of a source speech signal that is output by audio processor 23 from a source voice into a target voice, and to forward the resulting speech signal to speaker 24. This allows a user of device 2a to change voices of all speech signals that are output by audio processor 23, i.e. speech signals from mobile calls, from spoken mailbox menus, etc.

FIG. 2b depicts a further use-case of voice conversion in the context of a telecommunications device 2b. Therein, components of device 2b with the same function will be denoted with the same reference numerals as their counterparts in device 2a of FIG. 2a. The device 2b of FIG. 2b is not equipped with a complete voice conversion unit, as it is the case with device 2a in FIG. 2a. In contrast, only a decoder 12 is present, which is connected to CPU 22 and speaker 24. However, this decoder 12 is capable of decoding samples of encoding parameters that are received from CPU 22 to obtain speech signals that are then fed into speaker 24. Said samples of said encoding parameters may for instance be received by said device 2b from a core network of a mobile communications system said device 2b is operated in. Then, instead of transmitting speech data, said core network may use an encoder to encode said speech data into samples of encoding parameters, and these samples are then directly transmitted to device 2a. This is particularly advantageous if the samples of the encoding parameters represent speech signals that are frequently required and thus can be stored in the core network in the form of samples of encoding parameters. Said encoder in said core network may comprise a converter for performing voice conversion or not, and similarly, also decoder 12 in device 2b may comprise a converter for performing voice conversion or not. Alternatively, a separate conversion unit may be located on the path between said encoder in said core network and said decoder 12.

FIG. 2c depicts a third use-case of voice conversion in the context of a telecommunications device 2c, wherein CPU 22 is connected to a memory 25, in which samples of encoding parameters, which may for instance refer to frequently required speech signals, are stored. Said frequently required speech signals may for instance be spoken menu items that can be read to visually impaired persons for facilitating the use of device 2c. When such a menu shall be read to a user, CPU 22 fetches the corresponding samples of the encoding parameters from memory 25 and feds them into decoder 12, which decodes them into a speech signal that then can be emitted by speaker 24. As in the previous example, decoder 12 may be equipped with a converter for voice conversion or not, wherein in the former case, a personalization of the voice that reads the menu items to the user is possible. In the latter case, such a personalization may of course have been performed during the generation of said samples of encoding parameters by an encoder, or by a combination of an encoder and a converter. For instance, said samples of said encoding parameters may be pre-installed in the device, or may be received from a server in the core network of a mobile communications device said device 2c is operated in.

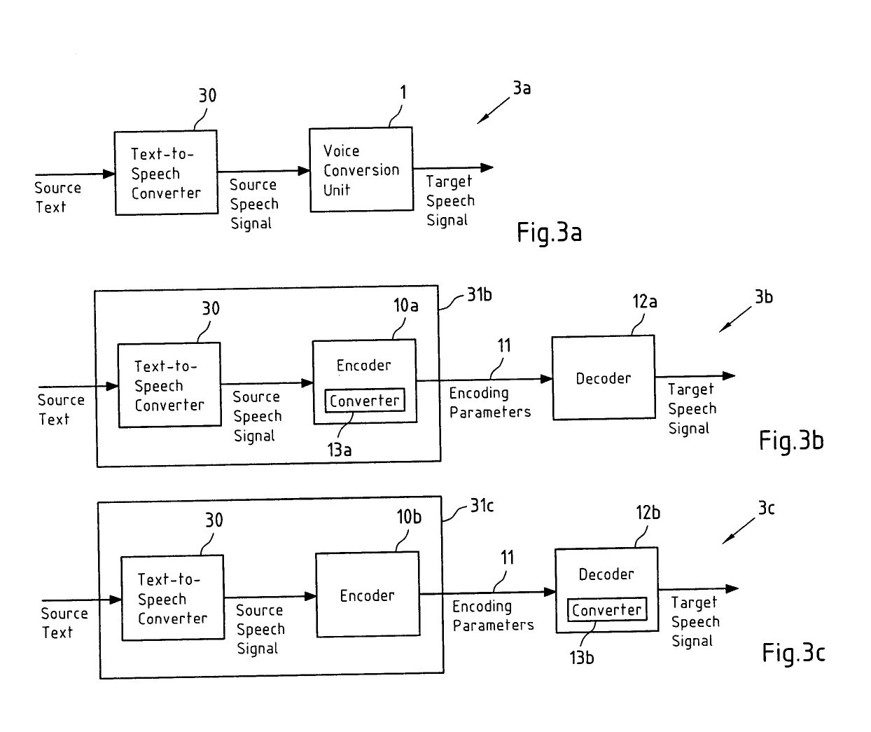

FIG. 3a illustrates an application of a framework for voice conversion according to the present invention in a Text-To-Speech (TTS) system 3a. This TTS system 3a comprises a voice conversion unit 1 according to framework 1a of FIG. 1a, framework 1b of FIG. 1b or framework 1c of FIG. 1c. The TTS system 3a further comprises a text-to-speech converter 30, which receives source text and converts this source text into a source speech signal. Said text-to-speech converter 30 may for instance have only one standard voice implemented, and thus it is advantageous that this voice can be changed by the voice conversion unit 1. Use-cases of such a TTS system 3a are for instance reading of Short Message Service (SMS) messages to a user of a telecommunications device, or reading of traffic information to a driver of a car via a car radio.

FIG. 3b illustrates a further embodiment of a TTS system 3b according to the present invention. The TTS system 3b comprises a unit 31b and a decoder 12a. In unit 31b, a text-to-speech converter 30 for converting a source text into a source speech signal, and an encoder 10a, for encoding said source signal into encoding parameters is comprised. Therein, encoder 10a is furnished with a converter 13b to perform the actual voice conversion for the source speech signal. The encoding parameters as output by instance 31b are then transferred to decoder 12a, which decodes the encoding parameters to obtain the target speech signal. According to the TTS system 3b, said unit 31b and said decoder 12a may for instance be housed in different devices (which are for instance connected by a wired or wireless link), and said unit 31b then performs text-to-speech conversion, encoding and conversion. Therein, the block structure of unit 31b is to be understood functionally, so that, equally well, all steps of text-to-speech conversion, encoding and conversion may be performed in a common block.

FIG. 3c illustrates a further embodiment of a TTS system 3c according to the present invention. In this TTS system 3c, text-to-speech converter 30 and encoder 10b form a unit 31c, wherein encoder 10b is not furnished with a converter as it was the case in unit 31b of TTS system 3b (see FIG. 3b). In contrast, in the TTS system 3c, the converter 13b is comprised in decoder 12b. Unit 31c thus only performs text-to-speech conversion and encoding, whereas decoder 12b takes care of the voice conversion and decoding. Similar to the TTS system 3b of FIG. 3b, in TTS system 3c, unit 31c and decoder 12b may be comprised in different devices, which are connected to each other via a wired or wireless link.

Exemplary embodiments of the encoder, decoder and converter of the voice conversion framework according to the present invention will now be presented with reference to FIGS. 4a-8. These embodiments partially use the Very Low Bit Rate (VLBR) codec proposed by NOKIA Corporation in U.S. patent application Ser. No. 10/692,290. The VLBR codec serves only as an example for a codec that allows for a encoding of a source speech signal under consideration of a segmentation of a source speech signal, wherein said segmentation depends on characteristics of said source speech signal. It is readily clear that, equally well, other encoding techniques exploiting segmentation of a source speech signal can be deployed without deviating from the scope of the present invention.

The VLBR codec uses a method of source speech signal segmentation for enhancing the coding efficiency of a typical parametric speech coder. The segmentation is based on a parametric model of the source speech signal, and is also used to model the target speech signal. The parametric model consists of several parameters, which are extracted from the source speech signal at regular intervals: Linear Prediction Coding (LPC) coefficients represented as Line Spectrum Frequencies (LSFs), pitch, voicing, gain (signal power/energy) and the spectral representation for the excitation. This model is roughly consistent with the human speech production system. The linear prediction scheme is a source-filter model in which the source approximately corresponds to the excitation and the filter models the vocal tract. The gain parameter has a connection to the loudness of speech whereas, during voiced speech, the pitch parameter corresponds to the fundamental frequency of the vibration of vocal cords. Furthermore, the voicing parameter defines the relationship between the periodic and noise-like speech components.

According to the VLBR codec exemplarily used by the voice conversion framework of the present invention, segments of the source speech signal are chosen such that the intra-segment similarity of the source parameters is high. Each segment is classified into one of a plurality of segment types, which segment types are based on the characteristics of the source speech signal. Preferably, the segment types are: silent (inactive), voiced, unvoiced and transition (mixed). As such, each segment can be coded by a coding scheme based on the corresponding segment type.

To illustrate the source speech signal segmentation, it is assumed that the voicing information is given as an integer value ranging from 0 (completely unvoiced) to 7 (completely voiced), and that the parameter samples are extracted at 10-ms intervals. Then, each parameter sample represents a frame of 10 ms (This frame may be understood as a fixed-size basic 10-ms segment, from which longer segments then are generated by way of combination, as will be explained below). However, the techniques can be adapted to work with other voicing information types and/or with different parameter sample extraction rates.

Based on the samples of the parameters related to speech energy and voicing, a simple segmentation algorithm can be implemented, for example, by considering the following points:
Silent, inactive segments of the source speech signal can be detected by setting a threshold for the energy value. In message pre-recording applications, the audio messages can be adjusted to have a constant input level and the level of background noise can be assumed very low.
The successive parameter sample extraction instants with an identical voicing value can be set to belong in a single segment.
Any 10-ms segment between two longer segments with the same voicing value can be eliminated as an outlier, such that the three segments can be combined into one long segment. Outliers are atypical data points, which do not appear to follow the characteristic distribution of the rest of the data.
A short (10-20 ms) segment between a completely voiced and a completely unvoiced segment may be merged into one of the neighboring segments if its voicing value is 1 or 2 (merge with the unvoiced segment), or 5 or 6 (merge with the voiced segment).
The successive segments with voicing values in the range from 1 to 6 can be merged into one segment. The type of these segments can be set to ‘transition’.
The remaining single 10-ms segments can be merged with the neighboring segment that has the most similar voicing value.

In addition, it is possible to use the other available source parameters in the segmentation. For example, if there is a drastic change in some parameter (e.g. in pitch) during a long voiced segment, the segment can be split into two parts so that the evolution of the parameter samples remains smooth in both parts.

According to the VLBR codec, the coding schemes for the parameter samples in the different segment types can be designed to meet perceptual requirements. For example, during voiced segments, high (quantization) accuracy is required but the update rate can be quite low. During unvoiced segments, low (quantization) accuracy is often sufficient but the update rate should be high enough.

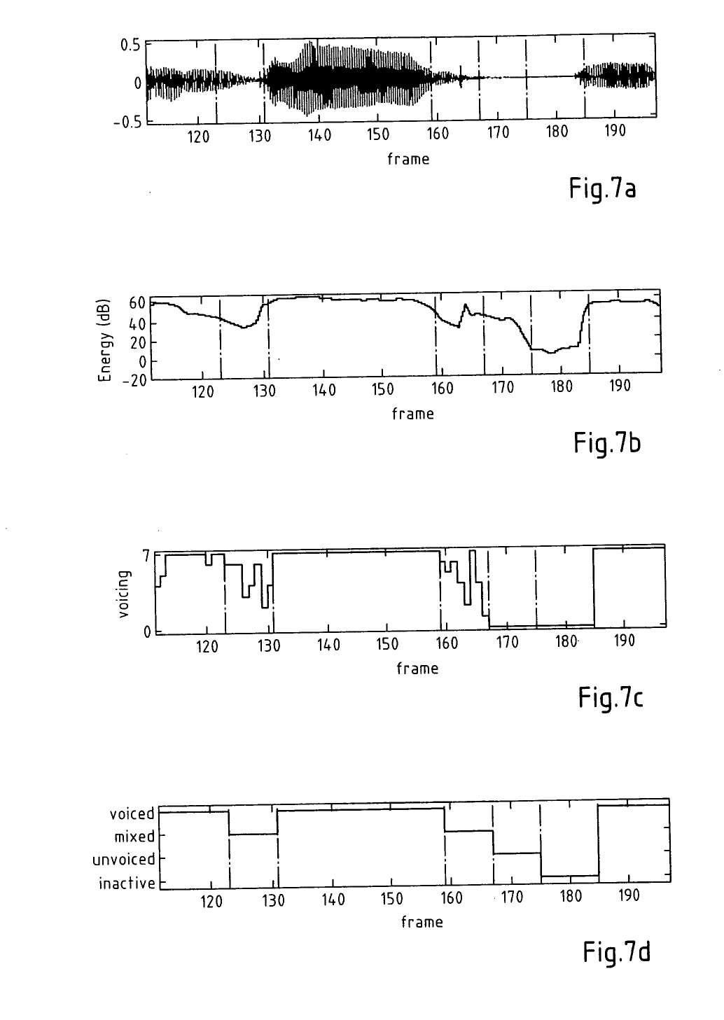

An example of a segmentation of a source speech signal is shown in FIGS. 7a-7d. FIG. 7a shows a part of a source speech signal plotted as a function of time. The corresponding energy (gain) parameter samples are shown in FIG. 7b, and the voicing information samples are shown in FIG. 7c. The segment type is shown in FIG. 7d. The vertical dashed lines in FIGS. 7a-7d illustrate the segment boundaries. In this example, the segmentation is based on the voicing and gain parameters. Gain (see FIG. 7b) is first used to determine whether a frame is active or not (silent). Then the voicing parameter is used to divide active speech to either unvoiced, transition or voiced segments (see FIG. 7d). This hard segmentation can later be redefined with smart filtering and/or using other parameters if necessary. Thus, the segmentation can be made based on the actual parametric speech coder parameters (either unquantized or quantized). Segmentation can also be made based on the original speech signal, but in that case a totally new segmentation block has to be developed.

FIG. 4a is a schematic block diagram of an encoder 4a according to the present invention. This encoder 4a is furnished with a converter 42, as it is the case with encoder 10a of the framework 1a for voice conversion of FIG. 1a. Encoder 4a is particularly arranged to encode a source speech signal into samples of encoding parameters, wherein said encoding comprises the step of segmenting said source speech signal into segments according to characteristics of said source speech signal, and wherein said encoding further comprises the step of converting samples of parameters related to said source speech signal (denoted as source parameters) into samples of parameters related to said target speech signal (denoted as target parameters). Therein, said encoding and/or said conversion depend on said segments said source speech signal has been segmented into.

Encoder 4a receives a source speech signal of limited length, which is first processed by a state-of-the-art parametric speech coder 40 to analyze a plurality of source parameters of said source speech signals, as for instance LPC coefficients or LSFs, pitch, voicing, gain and a spectral representation of the excitation. A plurality of series of samples of these source parameters are then provided, wherein a length of said series of samples is determined by the source parameter extraction rate (for instance 10 ms) and the length of the source speech signal input into the parametric speech coder 40.

The series of samples of the different source parameters are then input into segmentation instance 41, which performs segmentation of the series of samples of the source parameters as already explained above with reference to FIGS. 7a-7d. Therein, said segmentation for all source parameter series may for instance be determined by only one or two source parameters, for instance by the gain and/or voicing parameter.

After the segmentation instance 41, the encoder 4a works on a per-segment basis, wherein an exemplary segment is assumed to comprise k samples for each source parameter, respectively. Therein, it should be noted that, due to the segmentation as described above, the number k of samples of each segment generally changes from segment to segment.

The k samples of each source parameter of said exemplary segment are then fed into conversion instance 42, where they are converted into k samples of respective target parameters in order to perform the actual voice conversion from source to target voice. Conversion instance 42 receives the segment type of the actual segment of k samples from segmentation instance 41 and is controlled by a conversion control instance 47. This conversion control instance determines if conversion in dependence on the segment type is performed, or if conversion independent of the segment type is performed.

According to the present invention, it is assumed that the source and target parameters are related to the same type of parametric speech model. However, in conversion instance 42, nevertheless different conversion models are used for the conversion of samples of different source parameters. It should nevertheless be noted that the source and target parameters may equally well be related to different speech models, and then parameter conversion also has to take care of the proper mapping of the different models used. Details on parameter conversion will be discussed below.

As already stated, conversion instance 42 outputs k samples for each target parameter. In the following, target parameter x will be exemplarily considered, wherein said “x” is representative of the parameter type, as for instance pitch, gain, voicing, etc.

The k samples of all target parameters are then processed on a per-parameter basis by compression & quantization instance 46. This compression & quantization instance 46 comprises an adaptive downsampling and quantization instance 43, an instance 44 that determines a quantization mode and a target accuracy for the actual segment based on the segment type received from segmentation instance 41 and feeds this information into instance 43, and an encoding extent control instance 45.

Encoding extent control instance 45 controls instances 43 and 44 so that either an extent of said encoding performed by encoder 4a depends on the segments of the source speech signal or not. Therein, in this exemplary embodiment of encoder 4a, said extent of said encoding is characterized by an update rate for the samples of the encoding parameters and the number of bits allocated for a quantization of said samples.

In the compression-free case, encoding extent control instance 45 controls instance 43 to only perform quantization of the k samples of target parameter x, so that the output of compression & quantization instance 46, the i samples of encoding parameter x, are a quantized representation of the k samples of target parameter x. The value of i as output by the compression & quantization instance 46 then equals k. In this compression-free case, the update rate of the samples of encoding parameter x equals the update rate of the samples of target parameter x, which is basically determined by the parametric speech coder 40.

In this compression-free case, encoding extent control instance 45 then may control instance 44 to feed a default value indicating the number of quantization bits per sample to instance 43. It is readily clear that, in the compression-free case, it is still possible to adjust said extent of said encoding that is performed by encoder 4a in dependence on the segment types, for instance by assigning each segment type a different value indicating the number of bits allocated for quantization of each sample. Then for instance high quantization accuracy may be achieved during voiced segments, with correspondingly large extent of encoding, and low quantization accuracy may be achieved during unvoiced segments, with correspondingly small extent of encoding.

Furthermore, in the compression-free case, it is also possible to dispense with quantization at all, so that the i samples of encoding parameter x then equal the k samples of target parameter x.

Performing encoding without compression, i.e. with an extent of said encoding being independent of the actual segment type, may be particularly advantageous if a high quality of encoding is desired, or if computational effort that may be encountered in compression instance 46 shall be avoided. However, efficiency of encoding then may degrade, leading to increased required transmission bandwidths and/or memory requirements if said samples of said encoding parameters are to be transferred between devices.

In contrast, when encoding is performed with compression, i.e. with an extent of said encoding being dependent on said actual segment type, the k samples of target parameter x are compressed by compression & quantization instance 46 in dependence on the actual segment type, yielding i samples of encoding parameter x, which are then a downsampled representation of the k samples of target parameter x, and the value of i, wherein the factor k/i represents the downsampling factor. In this case, it is also possible to integrate quantization into the compression process or to dispense with quantization. In the first case, the i samples of encoding parameter x are then a downsampled and quantized representation of the k samples of target parameter x.

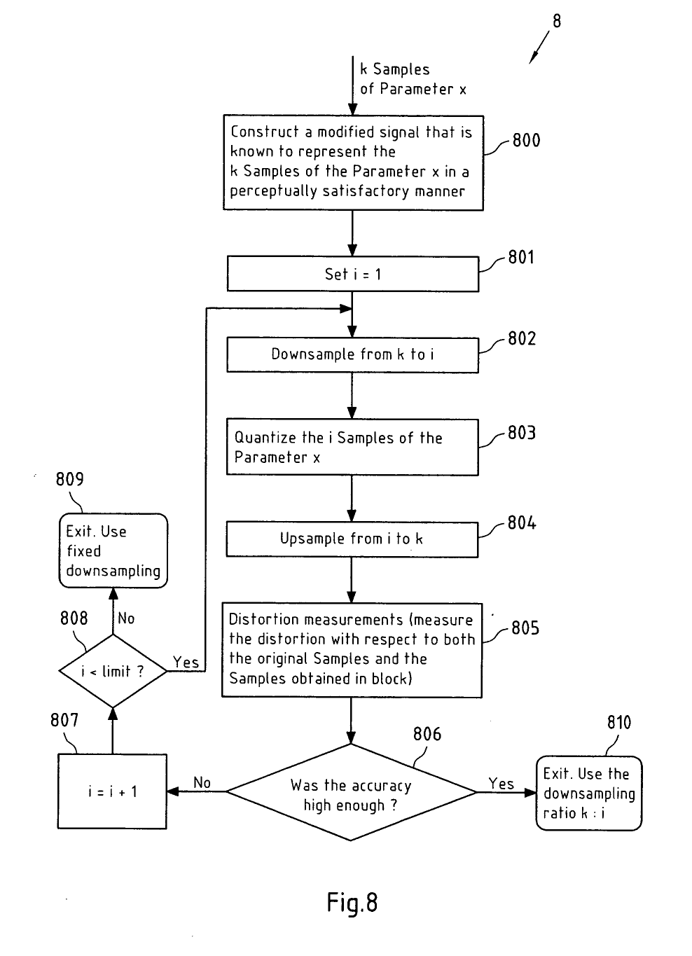

The algorithm for adaptive downsampling and quantization of the signal formed by the k samples of target parameter x as performed by adaptive downsampling and quantization instance 43 of FIG. 4a is illustrated in the flowchart 8 of FIG. 8. At step 800, a modified signal is formed from the k samples of parameter x. This modified signal has the same length and is known to represent the original signal in a perceptually satisfactory manner. At step 801, the optimization process is started at i=1. At step 802, the signal formed by the k samples of parameter x is downsampled from length k to i. At step 803, a quantizer, selected according to the quantizer mode determined by instance 44 (see FIG. 4a) is used to quantize the downsampled signal. At step 804, the resulting quantized signal is upsampled to the original length k again. At step 805, the distortion between the original k parameter samples and the k upsampled quantized parameter samples obtained at step 804 is measured. In addition, the distortion between the k upsampled quantized parameter samples obtained at step 804 and the modified signal obtained at step 800 is measured. At step 806, it is determined whether the distortion measurements indicate that the target accuracy determined by instance 44 of encoder 4a (see FIG. 4a) is achieved. It is sufficient that one of the two measurements carried out at step 805 conforms to the criteria. If the target accuracy is achieved, i is the number of parameter sample updates required in the current segment (step 810).

The quantized samples determined at step 803 then represent the i samples of the encoding parameters, and these samples and the value of i are output by instance 43 (see FIG. 4a). The i samples of adjacent segments and the corresponding values i then form a bitstream that is output by encoder 4a of FIG. 4a and for instance bound for a decoder. (The parameter k may, for example, be included in the segment information that is separately transmitted to the decoder).

If the target accuracy is not achieved at step 806, i is increased by one in step 807. If i does not exceed its maximum value, as determined at step 808, the process loops back to step 802. Otherwise, a fixed update rate that is known to be perceptually sufficient is used (step 809). This information is output by instance 43 (see FIG. 4a) together with the i samples of the encoding parameters, which are obtained by downsampling the k samples of parameter x from length k to i and quantizing the result.

As already stated, it is also possible to perform compression without quantization. The changes required to the algorithm of FIG. 8 are obvious for a person skilled in the art and thus are not discussed here in detail.

Encoder 4a is thus capable of encoding the source speech signal into samples of encoding parameters while performing voice conversion for the source speech signal. Therein, the segmentation performed for the source speech signal can be either exploited for voice conversion, which is controlled by conversion control instance 47, and/or for controlling an extent of said encoding (for instance in terms of parameter sample update rate compression and quantization extent), which is controlled by encoding extent control instance 45. If segment type information is exploited for voice conversion, different conversions may be performed for different segment types, thus increasing voice conversion quality. Exploiting voice conversion for the control of said extent of said encoding leads to a more efficient encoding of the speech signal and thus allows for low output bit rates of the encoder.

It is readily clear that the set-up of encoder 4a in FIG. 4a is of exemplary nature. For instance, in case that segment-type independent conversion is performed, conversion instance 42 may equally well be placed before segmentation instance 41.

FIG. 5a depicts a block diagram of a decoder 5a according to the present invention. This decoder 5a may be used to complement encoder 4a of FIG. 4a and thus to form a voice conversion framework 1a according to FIG. 1a. To this end, it is noted that decoder 5a is not furnished with a converter, as voice conversion has already been performed by encoder 4a.

Decoder 5a receives, segment per segment, the value i, which was used for downsampling at encoder 4a and indicates the number of samples of encoding parameter x, and the i samples of encoding parameter x, wherein both the value i and the i samples of the encoding parameter x are contained in a bitstream that is received by decoder 5a.

These i samples of encoding parameter x are then input into a decompression & dequantization instance 54, which comprises an upsampling and dequantization instance 50 and a control instance 53. Control instance 53 controls upsampling and dequantization instance 50 in accordance with information indicating whether compression and/or quantization has been performed during encoding of the samples of encoding parameter x or not. If no compression has been performed, control instance 53 furnishes instance 50 with the value indicating the number of bits allocated per sample for quantization, and instance 50 then may perform only dequantization of the i samples of encoding parameter x to obtain the k samples of target parameter x.

If compression has been performed at the encoder site, instance 50 performs upsampling and dequantization of the i samples of encoding parameter x to obtain the k samples of source parameter x, wherein said upsampling is based on information on the value of i and the value of k.

If neither compression nor quantization has been performed during encoding, instance 50 simply copies the i samples of encoding parameter x into the k samples of source parameter x.

It should be noted that, due to the downsampling and quantization operation, these k samples of target parameter x may differ from the k samples of target parameter x fed into instance 46 of FIG. 4a.

Based on the k samples of target parameter x, and on the k samples of the other target parameters that have been processed in a similar way, but eventually with different downsampling and/or quantization, a state-of-the-art parametric speech decoder 51 then is enabled to generate the target speech signal, which is a representation of the source speech signal, but is associated with a target voice instead of the source voice.

FIG. 4b and FIG. 5b depict block diagrams of an encoder 4b and a decoder 5b of a framework 1b for voice conversion according to FIG. 1b. In contrast to the encoder 4a and decoder 5a of FIGS. 4a and 5a, now decoder 5b is furnished with a conversion instance 52, and, correspondingly, no conversion is performed at the encoder 4b. This results in the k samples of source parameter x being input into compression & quantization instance 46 (and not the k samples of target parameter x being input into the compression & quantization instance 46 as in the encoder 4a), so that the i samples of encoding parameter x as output by instance 43 of encoder 4b are either a downsampled and quantized representation of the k samples of source parameter x (in case that compression is performed in compression & quantization instance 46), a quantized representation of the k samples of source parameter x (in case that no compression is performed in compression & quantization instance 46), or said k samples of source parameter x without change (in case that neither compression nor quantization is performed in compression & quantization instance 46).

After processing of these i samples of encoding parameter x in instance 50 of decoder 5b, which processing may either comprise upsampling and dequantization, dequantization, or no action at all, thus k samples of source parameter x are obtained (which may include errors due to downsampling and quantization and thus differ from the k samples of source parameter x used in the encoder 4b of FIG. 4b), and conversion has to be performed in instance 52 of decoder 5b in order to obtain k samples of target parameter x. Thus the actual voice conversion is now performed in instance 52 of decoder 5b. Therein, said conversion instance 52 is furnished with information on the current segment type to allow for optional segment-type dependent conversion, which is controlled by conversion control instance 55. The k samples of target parameter x as obtained from this conversion are, together with the k samples of the other target parameters, the processing of which is not shown in FIGS. 4b and 5b, fed into the state-of-the-art parametric speech decoder 51 to obtain the target speech signal associated with the target voice.

It should be noted that, from a complexity point of view, and in case that the encoding parameters have been quantized and compressed at the encoder, it may be more advantageous to perform the conversion in decoder 5b after dequantization of the i samples of encoding parameter x, but before upsampling of the result of this dequantization, because conversion then only has to be performed for i samples of source parameter x instead of k samples.

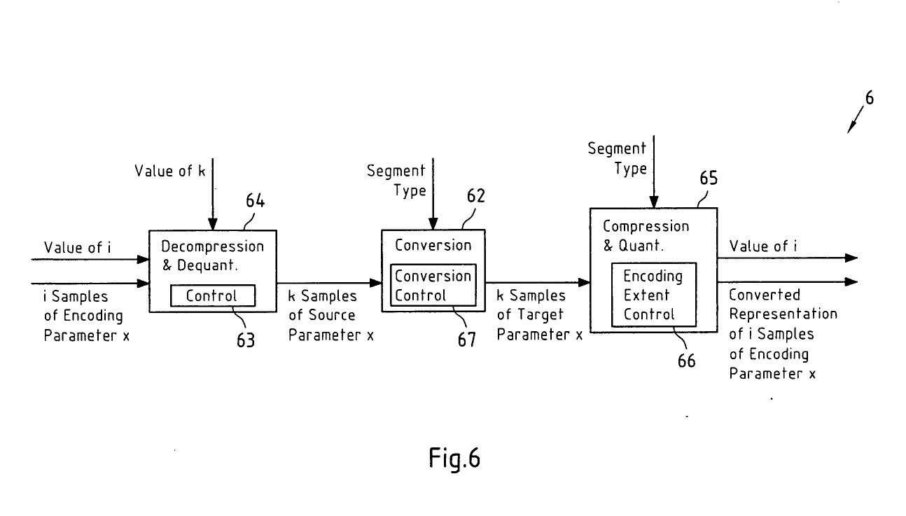

FIG. 6 depicts a schematic block diagram of an embodiment of a converter 6 for a framework 1c (see FIG. 1c) for voice conversion according to the present invention. According to this framework 1c, conversion is not integrated into an encoder (as in the framework 1a of FIG. 1a) or a decoder (as in the framework 1b of FIG. 1b), but forms a separate unit that is placed in the path between an encoder and a decoder. Said encoder may for instance be encoder 4b of FIG. 4b, and said decoder may for instance be decoder 5a of FIG. 5a.

Converter 6 comprises a decompression & dequantization instance 64, a conversion instance 62 and a compression & quantization instance 66.

Decompression & dequantization instance 64 of converter 6 may for instance be implemented like decompression & dequantization instance 54 deployed in the decoders 5a and 5b of FIGS. 5a and 5b, and thus be capable of dequantizing and/or upsampling samples of encoding parameter x as received from an encoder (for instance the encoder 4b of FIG. 4b), in order to obtain k samples of source parameter x.

Conversion instance 62 of converter 6 can be implemented similar to conversion instances 42 of FIGS. 4a and 52 of FIG. 5b, and converts k samples of source parameter x into k samples of target parameter x. Conversion instance 62 is controlled by a conversion control instance 67, so that either segment-type dependent or segment-type independent conversion is possible. To this end, conversion instance 62 is also furnished with information on the current segment type.

The k samples of target parameter x as obtained from conversion instance 62 then are fed into compression & quantization instance 66 for production of a converted representation of the i samples of encoding parameter x, which converted representation either equals said k samples of said target parameter x (in case no quantization and compression is performed in compression & quantization instance 66), or is a quantized representation of said samples (in case quantization is performed in compression & quantization instance 66), or is a quantized and downsampled representation of said samples (in case quantization and compression is performed in compression & quantization instance 66). Said converted representation of said i samples of said encoding parameters as output by said compression & quantization instance 66 of said converter 6 then may for instance be transferred to a decoder, for instance to decoder 5a of FIG. 5a. Compression & quantization instance 66 of converter is controlled by an encoding extent control instance 65, in order to control if an extent of said encoding shall depend on said segment type or not. To this end, encoding extent control instance 65 may control compression & quantization instance 66 to use the same value indicating the number of bits allocated for quantization per sample and the same downsampling factor k/i that were used for compression in compression & quantization instance 46 of encoder 4a (see FIG. 4a). Alternatively, adaptive compression may be performed by compression & quantization instance 66 of converter 6 based on a quantization mode and a desired target accuracy in dependence on the current segment type as already described with reference to FIG. 8 above.

From the above presentation of the embodiments of encoders, converters and decoders according to the present invention with reference to FIGS. 4a, 4b, 5a, 5b and 6, it is readily clear for a person skilled in the art that, when dispensing with specific functionalities of the present invention, the corresponding components of the embodiments can be further simplified. For instance, if no segment-type dependent conversion is desired, the conversion control instances 47 (see FIG. 4a), 55 (see FIG. 5b) and 67 (see FIG. 6) may not need to be implemented. Similarly, if no compression and quantization is required, all compression & quantization and decompression & dequantization instances 46 (FIGS. 4a and 4b), 54 (FIGS. 5a and 5b), 64 (FIG. 6) and 66 (FIG. 6) may not need to be implemented.

According to the present invention, conversion of samples of source parameters that are related to the source speech signal into samples of target parameters that are related to the target speech signal (as for instance conversion of the k samples of the source parameters to obtain the k samples of the target parameters in conversion instance 42 of FIG. 4a, in conversion instance 52 of FIG. 5b, or in conversion instance 62 of FIG. 6) can be performed in a plurality of ways. In the sequel, thus exemplary embodiments for the conversion of the parameters related to the vocal tract and of the parameters related to the excitation signal will be presented.

Conversion of the Vocal Tract Parameters

According to the present invention, conversion of the vocal tract is done using the line spectrum frequency representation. A conversion technique based on the GMM approach is used. The GMM model is trained using speech material from the source speaker (associated with the source voice) and the target speaker (associated with the target voice). Before training, the speech is aligned so that the source and target materials correspond with each other.

In particular, it is also possible to cluster the material into different categories that correspond to different segment types and to train a separate model for each cluster. It then becomes possible to have different conversion rules for different segment types, which may be exploited for segment-type dependent conversion in the conversion instances 42 (see FIG. 4a), 52 (see FIG. 5b) and 62 (see FIG. 6).

In addition, it is possible to take into account some context information in the training procedure. The training can be performed using traditional training techniques such as the Expectation-Maximization (EM) algorithm or a K-means type of training algorithm.

After the model has been properly trained, the conversion of the parameter vector is straightforward. The main idea is to take as input the source LSF vector (which represents the LSFs) and to use the model to generate the corresponding LSF vector with characteristics of the target speaker.

To optimize the performance even further, it is not necessary to use the LSF vectors obtained using the VLBR codec as such. Instead, in order to remove unwanted ripple-like effect (caused by the fact that the parameters of the vocal tract model are estimated by minimizing the energy of the excitation), it is possible to use formant tracking. In this way, the behavior is smoother and the model does not try to model random ripples.

Conversion of the Excitation Parameters

For the excitation, the pitch parameter may be considered as the most important parameter from the viewpoint of speaker identity. The pitch parameter can be converted using the same GMM-based conversion technique that was described in the conversion of the vocal tract parameters before, wherein also segment-type dependent conversion can be accomplished. Alternatively, it is also possible to convert the pitch parameter in a very simple manner, using only speaker-dependent means and variances for the conversion. Said means and variances then may also be determined for different segment types to accomplish segment-type dependent conversion. In addition, it is possible to use pitch parameter tracking to achieve smoother performance.

For the voicing parameter, there may be no crucial need for large changes. The simplest alternative is to leave the voicing parameter untouched. Another, slightly better, approach is to convert the voicing parameter using a simple model that captures the speaker-dependent differences in the degree of voicing. This can be performed in dependence on the segment types or independent of said segment types.

For the gain parameter, there may be no crucial need for large changes since the samples are mostly dependent on the input level and only secondarily on the speaker characteristics. However, for the best results, it is possible to take into account the timing of accented speech portions in the conversion model.

The spectral representation of the excitation may have some effect on the speaker identity, and thus it may be advantageous to include it into the conversion process. The spectral vectors (amplitudes and possibly phases) may be somewhat problematic for voice conversion because of the fact that the vector dimension is not fixed, but changes according to the changes in the pitch value. To solve this problem, it is possible to use some dimension conversion technique, based on for example Discrete Cosine Transform (DCT), but other techniques are also possible. After the conversion into fixed dimension, the voice conversion from source to target can be done in a manner similar to the one described above for the case of vocal tract parameters (again either dependent or independent of the segment type).

Conversion of the Speech Prosody

Some aspects of speech prosody (e.g. pitch and accent) may be inherently converted using the above-described conversion techniques, but the prosodic feature that has not yet been discussed is related to durations and timing. Clearly, these features are further important factors of speaker identity. With the framework for voice conversion according to the present invention, it is also possible to generate a model for taking into account the speaker-dependent aspects of these features.

The framework for voice conversion according to the present invention achieves very good performance in speaker identity modification and achieves an overall high speech quality. The framework is also particularly flexible due to the following reasons: Voice conversion can either be performed at the encoder, the decoder or in a separate unit; compression and/or conversion can be performed either dependent or independent of the segment type; it is possible to dispense with compression and/or quantization; and the quality of encoding can be traded against efficiency by choosing desired target accuracies during compression. The framework is basically compatible with existing speech processing solutions (for instance, state-of-the-art parametric speech coders and decoders can be deployed in the embodiments of the encoders and decoders, see FIGS. 4a, 4b, 5a and 5b). Due to its optional compression, the framework allows for efficient encoding of voice-converted speech on the one hand (see framework 1a of FIG. 1a), and also allows to perform voice conversion of compressed speech (see frameworks 1b and 1c of FIGS. 1b and 1c). This makes the framework suited for deployment in mobile applications with generally low transmission bandwidths and small memories. Furthermore, the computational complexity that has to be spent on encoding, conversion and decoding is particularly small. Finally, the framework of the present invention is suited for use in a variety of applications, as for instance text-to-speech conversion applications in all types of electronic devices such as multimedia and or telecommunications devices, or voice conversion applications in the context of mobile gaming and S2S.

The invention has been described above by means of exemplary embodiments. It should be noted that there are alternative ways and variations which are obvious to a person skilled in the art and can be implemented without deviating from the scope and spirit of the appended claims.

What is claimed is:

1. A method for converting a source speech signal associated with a source voice into a target speech signal that is a representation of said source speech signal associated with a target voice, said method comprising:
encoding said source speech signal into samples of encoding parameters, wherein said encoding comprises the step of segmenting said source speech signal into segments based on characteristics of said source speech signal,
decoding one of said samples of said encoding parameters and a converted representation of said samples of said encoding parameters to obtain said target speech signal, and
converting, in one of said encoding, said decoding and a separate step, samples of parameters related to said source speech signal into samples of parameters related to said target speech signal;
wherein at least one of said encoding and said converting depends on said segments of said source speech signal.

2. The method according to claim 1, wherein said encoding comprises the step of assigning said segments of said source speech signal segment types.

3. The method according to claim 2, wherein said converting of said samples of parameters related to said source speech signal into said samples of parameters related to said target speech signals depends on said assigned segment types.

4. The method according to claim 2, wherein an extent of said encoding of said source speech signal in said segments depends on said assigned segment types.

5. The method according to claim 4, wherein said extent of said encoding is related to at least one of update rates for said samples of said encoding parameters and numbers of bits allocated for a quantization of said samples of said encoding parameters.

6. The method according to claim 4, wherein said segment types are associated with desired accuracies in reconstructing of said source speech signal from said samples of said parameters related to said source speech signal, and wherein said extent of said encoding of said source speech signal in said segments depends on said desired accuracies.

7. The method according to claim 1, wherein said encoding parameters, said parameters related to said source speech signal and said parameters related to said target speech signal are parameters of a parametric speech signal model that comprises a vocal tract model and an excitation model.

8. The method according to claim 5, wherein said parameters related to said source and target speech signals comprise at least a pitch parameter, a voicing parameter, a gain parameter and spectral vectors representing an excitation of said source and target speech signals.

9. The method according to claim 1, wherein said parameters related to said source and target speech signals comprise line spectrum frequency coefficients, and wherein in said converting, samples of line spectrum frequency coefficients related to said source speech signal are converted into samples of line spectrum frequency coefficients related to said target speech signal based on a data-driven model that is trained with speech signal samples associated with said source voice and speech signal samples associated with said target voice.

10. The method according to claim 1, wherein said parameters related to said source and target speech signals comprise a pitch parameter, and wherein in said converting, samples of a pitch parameter related to said source speech signal are converted into samples of a pitch parameter related to said target speech signal based on a data-driven model that is trained with speech signal samples associated with said source voice and speech signal samples associated with said target voice.

11. The method according to claim 1, wherein said parameters related to said source and target speech signals comprise a pitch parameter, and wherein in said converting, samples of a pitch parameter related to said source speech signal are converted into samples of a pitch parameter related to said target speech signal based on moments of said source and target voice.

12. The method according to claim 1, wherein said parameters related to said source and target speech signals comprise a voicing parameter, and wherein in said converting, samples of a voicing parameter related to said source speech signal are converted into samples of a voicing parameter related to said target speech signal based on a model that captures the differences in the degree of voicing between said source and target voice.

13. The method according to claim 1, wherein said parameters related to said source and target speech signals comprise a gain parameter, and wherein in said converting, samples of a gain parameter related to said target speech signal are set equal to samples of a gain parameter related to said source speech signal.

14. The method according to claim 1, wherein said parameters related to said source and target speech signals comprise spectral vectors representing an excitation of said source and target speech signals, and wherein in said converting, samples of spectral vectors related to said source speech signal are converted into samples of spectral vectors related to said target speech signal based on a data-driven model that is trained with speech signal samples associated with said source voice and speech signal samples associated with said target voice.

15. The method according to claim 14, wherein in said converting, a dimension conversion technique is applied to said spectral vectors.

16. A device for converting a source speech signal associated with a source voice into a target speech signal that is a representation of said source speech signal associated with a target voice, said device comprising:
an encoder for encoding said source speech signal into samples of encoding parameters, wherein said encoder comprises means arranged for segmenting said source speech signal into segments based on characteristics of said source speech signal,
a decoder for decoding one of said samples of said encoding parameters and a converted representation of said samples of said encoding parameters to obtain said target speech signal, and
a converter for converting samples of parameters related to said source speech signal into samples of parameters related to said target speech signal, wherein said converter is comprised in one of said encoder, said decoder and a separate unit;
wherein at least one of said encoder and said converter are arranged to operate in dependence on said segments of said source speech signal.

17. The device according to claim 16, wherein said encoding parameters, said parameters related to said source speech signal and said parameters related to said target speech signal are parameters of a parametric speech signal model that comprises a vocal tract model and an excitation model.

18. The device according to claim 16, wherein said converter is arranged to convert samples of line spectrum frequency coefficients related to said source speech signal into samples of line spectrum frequency coefficients related to said target speech signal based on a data-driven model that is trained with speech signal samples associated with said source voice and speech signal samples associated with said target voice.

19. The device according to claim 16, wherein said converter is arranged to convert samples of a pitch parameter related to said source speech signal into samples of a pitch parameter related to said target speech signal based on a data-driven model that is trained with speech signal samples associated with said source voice and speech signal samples associated with said target voice.

20. The device according to claim 16, wherein said converter is arranged to convert samples of a pitch parameter related to said source speech signal into samples of a pitch parameter related to said target speech signal based on moments of said source and target voice.

21. The device according to claim 16, wherein said converter is arranged to convert samples of a voicing parameter related to said source speech signal into samples of a voicing parameter related to said target speech signal based on a model that captures the differences in the degree of voicing between said source and target voice.

22. The device according to claim 16, wherein said converter is arranged to set samples of a gain parameter related to said target speech signal equal to samples of a gain parameter related to said source speech signal.

23. The device according to claim 16, wherein said converter is arranged to convert samples of spectral vectors representing an excitation of said source speech signal into samples of spectral vectors representing an excitation of said target speech signal based on a data-driven model that is trained with speech signal samples associated with said source voice and speech signal samples associated with said target voice.

24. A software application product, embodied in an electronically readable medium for use in conjunction with a device for converting a source speech signal associated with a source voice into a target speech signal that is a representation of said source speech signal associated with a target voice, said software application product comprising:
program code for causing a digital processor to encode said source speech signal into samples of encoding parameters, said program code for causing said digital processor to encode said source speech signal into samples of encoding parameters comprising program code for causing said digital processor to segment said source speech signal into segments based on characteristics of said source speech signal,
program code for causing said digital processor to decode one of said samples of said encoding parameters and a converted representation of said samples of said encoding parameters to obtain said target speech signal, and
program code for causing said digital processor to convert, in one of said encoding, said decoding and a separate step, samples of parameters related to said source speech signal into samples of parameters related to said target speech signal;
wherein said program code causes said digital processor to perform at least one of said encoding operation and said converting operation in dependence on said segments of said source speech signal.

25. A device in a framework for converting a source speech signal associated with a source voice into a target speech signal that is a representation of said source speech signal associated with a target voice, said device comprising:
an encoder for encoding said source speech signal into samples of encoding parameters that lend themselves to decoding to obtain said target speech signal, wherein said encoder comprises means arranged for segmenting said source speech signal into segments based on characteristics of said source speech signal, wherein said encoder comprises a converter for converting samples of parameters related to said source speech signal into samples of parameters related to said target speech signal, and wherein at least one of said encoding and said converting depends on said segments of said source speech signal.

26. A device in a framework for converting a source speech signal associated with a source voice into a target speech signal that is a representation of said source speech signal associated with a target voice, said device comprising:
a converter for converting samples of encoding parameters into a converted representation of said samples of said encoding parameters, wherein said samples of said encoding parameters are encoded from a source speech signal, wherein said encoding comprises the step of segmenting said source speech signal into segments based on characteristics of said source speech signal, wherein said converted representation of said samples of said encoding parameters lends itself to decoding to obtain said target speech signal, and wherein at least one of said encoding and said converting depends on said segments of said source speech signal.

27. A device in a framework for converting a source speech signal associated with a source voice into a target speech signal that is a representation of said source speech signal associated with a target voice, said device comprising:
a decoder for decoding samples of encoding parameters to obtain said target speech signal, wherein said samples of said encoding parameters are obtained by encoding said source speech signal, wherein said encoding comprises the step of segmenting said source speech signal into segments based on characteristics of said source speech signal, wherein said decoder comprises a converter for converting samples of parameters related to said source speech signal into samples of parameters related to said target speech signal, and wherein at least one of said encoding and said converting depends on said segments of said source speech signal.

28. A telecommunications device being capable of converting a source speech signal associated with a source voice into a target speech signal that is a representation of said source speech signal associated with a target voice, said telecommunications device comprising:
an encoder for encoding said source speech signal into samples of encoding parameters, wherein said encoder comprises means arranged for segmenting said source speech signal into segments based on characteristics of said source speech signal,
a decoder for decoding one of said samples of said encoding parameters and a converted representation of said samples of said encoding parameters to obtain said target speech signal, and
a converter for converting samples of parameters related to said source speech signal into samples of parameters related to said target speech signal, wherein said converter is comprised in one of said encoder, said decoder and a unit that is separate from said encoder and said decoder;
wherein at least one of said encoder and said converter are arranged to operate in dependence on said segments of said source speech signal.

29. A text-to-speech system being capable of converting a source speech signal associated with a source voice into a target speech signal that is a representation of said source speech signal associated with a target voice, said text-to-speech system comprising:
a text-to-speech converter for converting a source text into said source speech signal;
an encoder for encoding said source speech signal into samples of encoding parameters, wherein said encoding comprises the step of segmenting said source speech signal into segments based on characteristics of said source speech signal,
a decoder for decoding one of said samples of said encoding parameters and a converted representation of said samples of said encoding parameters to obtain said target speech signal, and
a converter for converting samples of parameters related to said source speech signal into samples of parameters related to said target speech signal, wherein said converter is comprised in one of said text-to-speech converter, said encoder, said decoder and a unit that is separate from said text-to-speech converter, encoder and decoder;
wherein at least one of said encoder and converter is arranged to operate in dependence on said segments of said source speech signal.
